(19) United States
(12) Patent Application Publication
(10) Pub. No.: US 2026/0370536 A1
(43) Pub. Date: Nov. 19, 2026

(54) DYNAMIC COMPENSATION FOR SIGNAL DISTORTION

(71) Applicant: T-MOBILE INNOVATIONS LLC, Overland, KS (US)

(72) Inventor: Chaitanya CHUKKA, Plainfield, IL (US)

(21) Appl. No.: 19/210,939

(22) Filed: May 16, 2025

(51) Int. Cl. H04L 27/36; H04L 25/03; H04L 27/38

(52) U.S. Cl. CPC H04L 27/366; H04L 25/03006; H04L 27/3863

(57) ABSTRACT

Systems and methods for dynamically compensating for signal distortion between a non-terrestrial node and a user device are provided. Initially, orbital state information associated with the non-terrestrial node is determined. Based at least on communication signaling, a location associated with the user device that is connected to the non-terrestrial node is determined. Baseband signal components, such as In-phase (I) and Quadrature (Q) values, are calculated for carrier frequency adjustment based at least on the determined location of the user device and the orbital state information. Further, based on the baseband signal components, an amplitude and a phase of baseband signal carriers are adjusted to compensate for the signal distortion.

### SUMMARY

The present disclosure is directed to the dynamic compensation of Doppler effect or other signal degradation in Non-Terrestrial Networks using adaptive carrier processing at the baseband level. These approaches address the significant challenges posed by Doppler shift, which can cause loss of communication between user devices and non-terrestrial nodes, resulting in higher latency and Key Performance Indicator (KPI) degradation, substantially as shown and/or described in connection with at least one of the Figures, and as set forth more completely in the claims.

According to various aspects of the technology, methods and systems are provided for dynamically compensating for signal distortion between a non-terrestrial node and a user device. In particular, orbital state information associated with the non-terrestrial node may be determined, and based at least on communication signaling, a location associated with the user device that is connected to the non-terrestrial node may also be determined. Baseband signal components, such as In-phase (I) and Quadrature (Q) values, are calculated for carrier frequency adjustment based at least on the determined location of the user device and the orbital state information. Based on the baseband signal components, the amplitude and phase of baseband signal carriers are adjusted to compensate for the signal distortion.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a diagram of an exemplary environment in which implementations of the present disclosure may be employed;

FIG. 2 illustrates a diagram of an exemplary environment in which implementations of the present disclosure may be employed;

FIGS. 3-5 depict flow diagrams of exemplary methods for dynamically compensating for signal distortion between a non-terrestrial node and a user device, in accordance with embodiments described herein; and

FIG. 6 illustrates an exemplary computing device for use with the present disclosure.

### DETAILED DESCRIPTION

The Doppler effect poses a significant challenge in Non-Terrestrial Networks, causing loss of communication between user devices and non-terrestrial nodes. This phenomenon results in higher latency and degradation of Key Performance Indicators (KPIs), particularly when dealing with data transmission. As used herein, degradation of KPIs may include latency, throughput, packet loss, signal quality, or the like, and are effectively mitigated through dynamic adjustments to carrier frequency, amplitude, and phase of baseband signal carriers. Doppler effect occurs due to the relative motion between the satellite and the user device, leading to variations in the frequency of the transmitted signal. These variations can disrupt communication, especially in scenarios involving high-speed satellites and mobile user devices.

The aspects provided herein offer a novel solution to dynamically compensate for the Doppler effect using adaptive carrier processing at the baseband level. By adjusting the carrier frequency pre-modulation, the system avoids radio frequency (RF) interference and ensures accurate signal transmission. The solution leverages at least two parameters: Epoch time and ephemeris data, which provide precise information about the satellite's orbit and velocity. An intelligent algorithm processes these parameters to calculate optimal I/Q values, adjusting amplitude and phase to negate the Doppler shift pre-emptively. This continuous operation ensures that the user device receives the correct transmission, thereby reducing latency and improving KPIs.

Additionally, the aspects provided herein address latency and miscommunication issues caused by the double motion of satellites and Earth. By introducing an additional algorithm sequence, the system solves both the Doppler effect and latency problems, ensuring seamless communication between the user device and the non-terrestrial nodes. Leveraging advancements in System on Chip (SoC) technology, the solution utilizes the processing power of baseband hardware to perform these calculations and adjustments efficiently. The mathematical approach involves using Fourier transforms to adjust transient parameters within the equation, changing the modulation output to reduce or increase delay. This comprehensive solution ensures reliable and efficient communication between user devices and non-terrestrial nodes, paving the way for future data transmission capabilities.

As mentioned, to mitigate these issues, the aspects provided herein propose adjusting the carrier frequency at the baseband level, thereby avoiding RF interference pre-modulation. This adjustment is based on two critical parameters: Epoch time and ephemeris data. Epoch time indicates the satellite's orbit at a specific point, along with a set of orbital elements, while ephemeris data contains position and velocity state information of the satellite during a given period. By interpolating ephemeris data via the makima interpolation method to align with scenario time steps, the system can dynamically adjust the carrier frequency to compensate for Doppler shift.

The core of the aspects provided herein lies in its intelligent algorithm, which senses incoming parameters and calculates optimal I/Q values. These values are adjusted to negate the Doppler shift pre-emptively, ensuring that the user device receives the correct transmission. The algorithm operates continuously, detecting the location of the user device and calculating the appropriate amplitude and phase values of the I/Q carriers. By modifying the weights of these carriers, the system can completely negate the Doppler shift.

Additionally, the aspects provided herein address latency and miscommunication issues caused by the double motion of satellites and Earth. An additional algorithm sequence is introduced to solve both the Doppler effect and latency problems, ensuring seamless communication between the user device and the non-terrestrial nodes.

Leveraging advancements in System on Chip (SoC) technology, the aspects provided herein utilize the processing power of baseband hardware to perform these calculations and adjustments. The mathematical approach involves using Fourier transforms to adjust transient parameters within the equation, changing the modulation output to reduce or increase delay.

As such, aspects provided herein offer a comprehensive solution to dynamically compensate for the Doppler effect in non-terrestrial nodes, using adaptive carrier processing at the baseband level. By intelligently adjusting carrier frequencies based on Epoch time and ephemeris data, and addressing latency issues, these aspects ensure reliable and efficient communication between user devices and non-terrestrial nodes.

In a first aspect, a method is provided for dynamically compensating for signal distortion between a non-terrestrial node and a user device. The method includes determining orbital state information associated with the non-terrestrial node, and based at least on communication signaling, determining a location associated with the user device that is connected to the non-terrestrial node. The method further includes calculating baseband signal components for carrier frequency adjustment based at least on the determined location of the user device and the orbital state information, and based on the baseband signal components, adjusting the amplitude and phase of baseband signal carriers to compensate for the signal distortion.

In a second aspect, a system is provided for dynamically compensating for signal distortion. The system includes a non-terrestrial node configured to provide wireless coverage to a user device, and one or more computer processing components configured to perform operations. The operations include receiving an indication that signal distortion is present based on communications between the non-terrestrial node and the user device, determining orbital state information associated with the non-terrestrial node, and based at least on communication signaling, determining a location associated with the user device that is connected to the non-terrestrial node. The operations further include calculating baseband signal components for carrier frequency adjustment based at least on the determined location of the user device and the orbital state information. Further, the operations include based on the baseband signal components, adjusting the amplitude and phase of baseband signal carriers to compensate for the signal distortion, and implementing a feedback loop to continuously monitor and update the baseband signal components based on changes in the location of the user device and the orbital state information.

In a third aspect, a method is provided for dynamically compensating for signal distortion between a non-terrestrial node and a user device. The method includes determining, at the user device, that the user device is connected to a non-terrestrial node, and based on communication signaling, determining the presence of the signal distortion. Further, the method includes determining orbital state information associated with the non-terrestrial node and location information associated with the user device and adjusting an amplitude and a phase of baseband signal carriers to compensate for the signal distortion on uplink communications.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

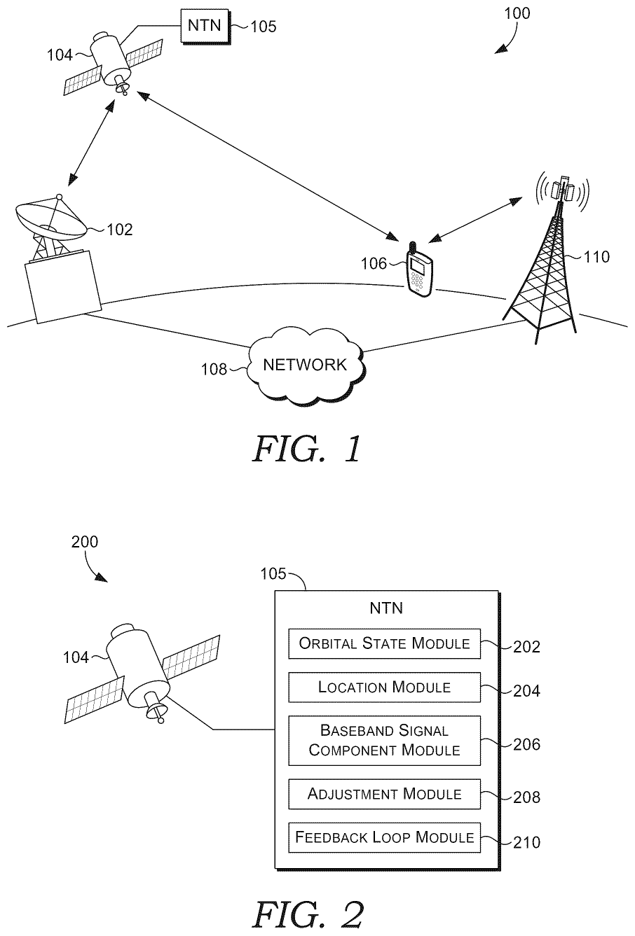

Turning now to FIG. 1, a representative network environment is illustrated in which implementations of the present disclosure may be employed. Such a network environment is illustrated and designated generally as network environment 100. At a high level the network environment 100 comprises a satellite radio access network (RAN) a terrestrial RAN, a user device 106, and a network 108. In aspects, the satellite RAN comprises at least a gateway 102 and a satellite 104. Though the composition of network environment 100 illustrates objects in the singular, it should be understood that more than one of each component is expressly conceived as being within the bounds of the present disclosure; for example, the network environment 100 may comprise multiple gateways, multiple distinct networks, multiple user devices, multiple satellites that communicate with a single gateway or multiple gateways, multiple satellites that may have inter-satellite links, multiple terrestrial base stations, and the like. Though certain objects of network environment 100 are illustrated in a certain form, it should also be understood that they may take other forms; for example, even though the user device 106 is illustrated as a cellular phone, a user device suitable for implementations with the present disclosure may be any computing device having any one or more aspects described with respect to FIG. 1, and even though the terrestrial base station 110 is illustrated as a macro cell mounted on a tower, a terrestrial base station suitable for use with the present disclosure is any terrestrial station configured to transmit signals to and receive signals from the user device 106 (e.g., a small cell, pico cell, relay, and the like).

The gateway 102 may be said to be communicatively connected to the network 108 and the satellite 104. The gateway 102 may be connected to the network 108 via one or more wireless or wired connections and is connected to the satellite 104. The gateway 102 may take the form of a device or a system of components configured to communicate with the user device 106 via the satellite 104 and to provide an interface between the network 108 and the satellite 104. Generally, the gateway 102 utilizes one or more antennas to transmit and receive signals to/from the satellite 104. The gateway 102 may communicate with a plurality of satellites, including the satellite 104. The network 108 comprises any one or more public or private networks, any one or more of which may be configured as a satellite network, a publicly switched telephony network (PSTN), or a cellular telecommunications network. In aspects, the network 108 may comprise a satellite network connecting a plurality of gateways (including the gateway 102) to other networks, a cellular core network (e.g., a 4G, 5G, of 6G core network, an IMS network, and the like), and a data network. In such aspects, each of the satellite network and the cellular core network may be associated with a network identifier such as a public land mobile network (PLMN), a mobile country code, a mobile network code, or the like, wherein the network identifier associated with the satellite network is the same or different than the network identifier associated with the cellular network.

The satellite 104 is generally configured to provide wireless communication service to the user device 106 while in a satellite coverage area. In aspects where the satellite 104 is a bent pipe type, the satellite 104 may primarily operate by relaying communications between the gateway 102 and the user device 106. In aspects where the satellite 104 is processing or regenerative type, the satellite 104 may handle at least some signal processing, routing, switching, and resource allocation/scheduling on board, while still using a connection to the gateway 102 as a backhaul to the network 108. The satellite 104 communicates with the gateway using the feeder link and communicates with the user device 106 using a user link. The user link comprises a forward downlink used to communicate signals from the satellite 104 to the user device 106 and a return uplink used to communicate signals from the user device 106 to the satellite 104. Though a single forward downlink and a single return uplink are illustrated, the user device 106 may utilize multiple downlinks and/or multiple uplinks to communicate with the satellite 104, using any one or more frequencies as desired by a satellite or network operator. The satellite 104 may communicate with the user device 106 using any wireless telecommunication protocol desired by a network operator, including but not limited to 3G, 4G, 5G, 6G, 802.11x, Bluetooth and the like.

Satellite 104 may comprise a non-terrestrial node 105, which may be manufactured as an integrated part of satellite 104 or a separate component. Non-terrestrial node 105 may be described in a similar way as satellite 104, as it orbits as the satellite 104 does. Non-terrestrial node 105 may be responsible for communications with user device 106, and may have the same functionality as a terrestrial node, such as node 110, which could be a gNodeB, eNodeB, etc. The orbit of any particular satellite will vary by operator desire and/or intended use. For example, a satellite suitable for use with the present disclosure may be characterized by its maximum orbital altitude and/or orbital period as Low Earth Orbit (LEO), Medium Earth Orbit (MEO), and High Earth Orbit (HEO). In such aspects, the orbit of the non-terrestrial node 105 may proceed such that the user device 106 is no longer within the coverage area of non-terrestrial node 105, but the user device 106 may now be within a coverage area of another non-terrestrial node. In such aspects, the user device 106 may be handed over from the non-terrestrial node 105 to another non-terrestrial node to preserve the connection to the non-terrestrial network.

As mentioned, the network environment 100 includes one or more networks, represented by network 108. Network 108 comprises any one or more public or private networks, and may be used for terrestrial nodes as well as non-terrestrial nodes. Network 108 may be configured according to one or more network architectures and/or principles, such as conventional RAN, cloud-based RAN, and/or open RAN technologies. In some aspects, network 108 is a non-terrestrial core network. In some aspects, network 108 may be configured as a satellite network connecting to a plurality of gateways, such as the gateway 102. The user device 106 may communicate with network 108 via one or more non-terrestrial nodes, such as the non-terrestrial node 105. In aspects, network 208 utilizes a first frequency range to communicate with one or more user devices (e.g., the user device 106).

The network environment 100 includes one or more terrestrial networks, such as network 108. Network 108 comprises any one or more public or private networks. Network 108 may be configured according to one or more network architectures and/or principles, such as conventional RAN, cloud-based RAN, and/or open RAN technologies. Network 108 may comprise a terrestrial core network. Although shown as a single network, network 108 may comprise one or more networks, such as a terrestrial network and a non-terrestrial network. In some aspects, the network 108 may comprise a cellular telecommunications network (e.g., a 4G, 5G, or 6G core network, an IMS network, and the like), a data network, and/or a publicly switched telephony network (PSTN). The user device 106 may communicate with network 108 via one or more terrestrial base stations, such as terrestrial node 110.

FIG. 2 depicts a representative network environment 200 in which implementations of the present disclosure may be employed. Network environment 200 includes satellite 104 and non-terrestrial node 105. Non-terrestrial node 105, in aspects, performs several functions of the present disclosure. Non-terrestrial node 105 may include, for example, an orbital state module 202, a location module 204, a baseband signal component module 206, an adjustment module 208, and a feedback loop module 210. Orbital state module 202 is responsible for gathering information on the satellite. Some of this information may include ephemeris data and epoch time, as well as other parameters associated with the satellite.

Initially, ephemeris data includes the position and velocity state information of a satellite over a period of time. This data is used to track the satellite's trajectory and understanding its current and future positions. Non-terrestrial nodes obtain ephemeris data through a onboard system or ground control. For obtaining it through onboard systems, it could be from a satellite sensor, which continuously monitors their position and velocity which is then used to generate ephemeris data, of from internal memory. For obtaining it through ground control, it could be from a ground station, which tracks the satellite's position and velocity using radar and other tracking technologies, or data transmission, which tracks the satellite's position and velocity using radar and other tracking technologies.

Epoch time, on the other hand, refers to a specific point in time that serves as a reference for the satellite's orbit. It includes a set of orbital elements that describe the satellite's position and trajectory at that particular moment. Non-terrestrial nodes determine epoch time through an onboard system or ground control. When using an onboard system, a satellite clock may be used that is synchronized with ground control systems to ensure accuracy. An orbital element may also be used, which is the satellite's onboard system that uses the clock and sensors to determine its position at specific epoch times, generating the necessary orbital elements. When ground control is used, ground control systems synchronize with the satellite's onboard clock, providing accurate epoch time references. Or, ground stations may perform calculations based on the satellite's observed position and velocity to determine its orbital elements at specific epoch times.

With continued reference to FIG. 2, location module 204 is responsible for determining location information associated with the user device that is communicating with the non-terrestrial node 105. The user device, when sending control signaling, may include its location information, including at least one of latitude, longitude, altitude, angle of arrival, or the like. This information may also come from a terrestrial node. Baseband signal component module 206 is responsible for calculating baseband signal components based on the user device's location and the orbital state information. In some aspects, baseband signal components may be I/Q values. The In-phase component represents the part of the signal that is in phase with the reference signal. It corresponds to the real part of the complex signal. It carries the amplitude information of the signal without any phase shift. Essentially, it is the projection of the signal onto the reference axis. The Quadrature component represents the part of the signal that is 90 degrees out of phase with the reference signal. It corresponds to the imaginary part of the complex signal. It carries the amplitude information of the signal with a phase shift of 90 degrees. It is the projection of the signal onto the orthogonal axis. I/Q components are used in various modulation schemes such as Quadrature Amplitude Modulation (QAM) and Phase Shift Keying (PSK). These schemes modulate both the amplitude and phase of the carrier signal to encode information. In baseband processing, the I/Q components are combined to form the complex signal that is then modulated onto a carrier frequency. This allows for efficient transmission and reception of data. For example, a complex signal can be represented as S(t)=I(t)+jQ(t)S(t)=I(t)+jQ(t), where I(t)I(t) is the In-phase component and Q(t)Q(t) is the Quadrature component.

The adjustment module 208 is responsible for adjusting the amplitude and phase of the I/Q components of baseband signal carriers to compensate for the frequency shift, and in some aspects, this occurs preemptively. In some aspects, System on Chip (SoC) technology may be used to perform the calculations and adjustments within the baseband hardware of the satellite. In some aspects, the Fourier transform is used for this calculation. The Fourier transform is used to analyze the frequency content of the baseband signal components. By transforming the signal into the frequency domain, transient parameters within the modulation equation can be adjusted. This helps in changing the modulation output to reduce or increase delay and improve communication reliability. By applying the Fourier transform, the system can identify and compensate for distortions in the signal caused by the Doppler effect or other factors. This ensures that the adjusted signal maintains its integrity during transmission.

Feedback loop module 210 is used to continuously monitor and adjust the carrier frequency to dynamically compensate for the Doppler effect in the non-terrestrial network. This ensures accurate and reliable communication between the user devices and the non-terrestrial node/satellites. Further, the feedback loop continuously monitors the relative position of the user device and the satellite. It updates the baseband signal components based on changes in the relative position, ensuring dynamic compensation for the Doppler effect. This involves real-time sensing of incoming parameters and recalculating the optimal I/Q values as the satellite and user device move. Having a feedback loop ensures continuous and dynamic compensation for the Doppler effect or other signal degradation in non-terrestrial node systems. By leveraging real-time data, advanced processing power, and mathematical adjustments, the system maintains accurate and reliable communication between the user device and the satellite.

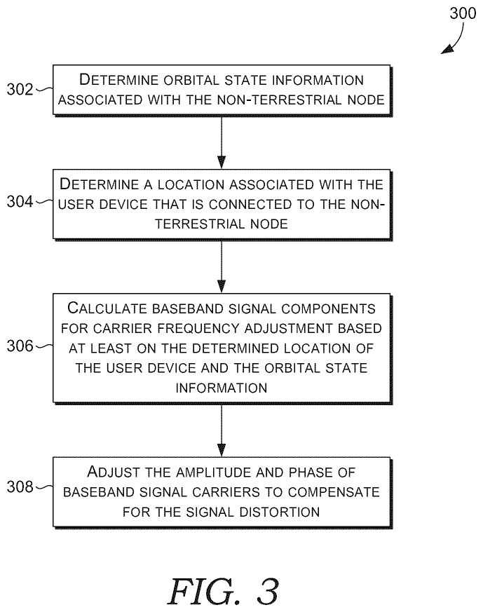

Turning now to FIG. 3, a flow chart representing a method 300 for dynamically compensating for signal distortion between a non-terrestrial node and a user device is provided. At block 302, orbital state information associated with the non-terrestrial node is determined. The orbital state information, in one aspect, includes ephemeris data and epoch time data. The ephemeris data includes position and velocity state information of the satellite during a given period, while the epoch time data indicates the satellite's orbit at a specific point along with a set of orbital elements. These data sets provide a comprehensive understanding of the satellite's trajectory and current location, which are used for accurate calculations.

At block 304, based at least on communication signaling, determining the location associated with the user device that is connected to the non-terrestrial node. This determination is based at least on communication signaling received from the user device. The communication signals may include angle of arrival, latitude, longitude, and altitude information. By analyzing these signals, the system can pinpoint the geographical coordinates of the user device, ensuring precise location data for subsequent calculations.

At block 306, based on the orbital state information and the location associated with the user device, baseband signal components are calculated for carrier frequency adjustment. IN one aspect, the baseband signal components are I/Q values for the carrier frequency adjustment. Additionally, the calculation takes into account the distance between the non-terrestrial node and the user device, as well as the angular velocity of the non-terrestrial node.

At block 308, based on the baseband signal components, amplitude and phase are adjusted to compensate for the signal distortion to preemptively negate the signal distortion. In aspects, the baseband signal components are I/Q components, where I component is the part of the signal that is in phase with the reference signal, and the Q component is 90 degrees out of phase with the reference signal. I/Q components are used in modulation schemes to represent the amplitude and phase of the signal. They are the real and imaginary parts of the complex signal, respectively. From the I/Q components, amplitude and phase values are derived, which describe the magnitude and phase angle of the signal. These values can be derived from the I/Q components. Amplitude represents the strength of the signal, while phase represents the shift of the signal relative to a reference.

Additionally, Fourier transforms are applied to the baseband signal components to adjust transient parameters within the modulation equation, thereby changing the modulation output to reduce or increase delay and improve communication reliability. The method may also implement a feedback loop to continuously monitor and update the baseband signal components based on changes in the location of the user device and the orbital state information, ensuring dynamic compensation for signal distortion.

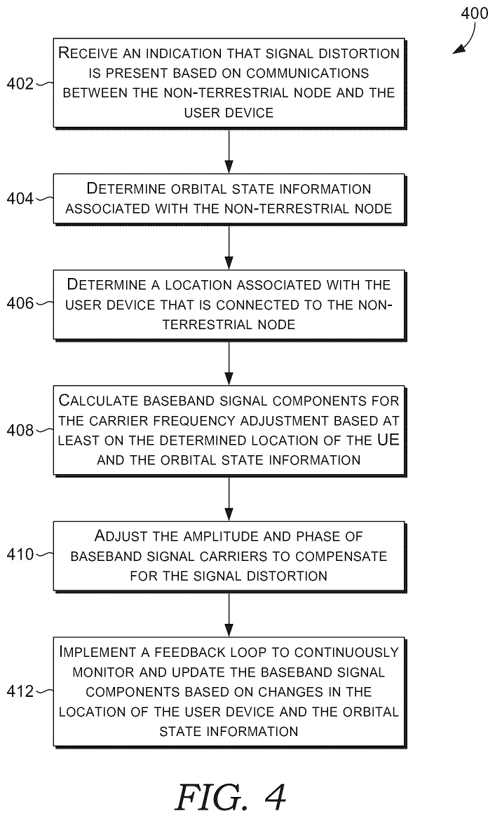

FIG. 4. depicts a flow chart representing a method 400 for dynamically compensating for signal distortion between a non-terrestrial node and a user device. At block 402, an indication is received that signal distortion is present. This indication is based on the communications between the non-terrestrial node (such as a satellite or attached/communicating with a satellite) and the user device. Signal distortion can manifest as changes in frequency, phase, or amplitude of the received signal, which may be caused by the Doppler effect or other factors. The system detects these distortions through monitoring the communication signals exchanged between the non-terrestrial node and the user device. At block 404, orbital state information associated with the non-terrestrial node is determined. The orbital state information may include receiving ephemeris data and epoch time data. The ephemeris data provides position and velocity state information of the satellite during a given period, while the epoch time data indicates the satellite's orbit at a specific point along with a set of orbital elements. These data sets are used for understanding the satellite's trajectory and current location, which are needed for accurate calculations.

At block 406, a location associated with the user device that is connected to the non-terrestrial node is determined. The communication signals from the user device may include angle of arrival, latitude, longitude, and altitude information. By analyzing these signals, the system can pinpoint the geographical coordinates of the user device, ensuring precise location data for subsequent calculations. At block 408, based on the orbital state information and the location associated with the user device, the baseband signal components for carrier frequency adjustment are calculated. This calculation involves determining optimal I/Q values for the carrier frequency adjustment. Additionally, the calculation takes into account the distance between the non-terrestrial node and the user device, as well as the angular velocity of the non-terrestrial node. These factors are used for accurately adjusting the carrier frequency to compensate for signal distortion.

At block 410, the amplitude and phase of the baseband signal carriers are adjusted to compensate for the signal distortion. The amplitude and phase, in some aspects, are I/Q components, which are adjusted to preemptively negate the signal distortion. Additionally, Fourier transforms are applied to adjust transient parameters within the modulation equation, thereby changing the modulation output to reduce or increase delay and improve communication reliability. At block 412, a feedback loop is implemented to continuously monitor and update the baseband signal components based on changes in the location of the user device and the orbital state information. This feedback loop ensures dynamic compensation for signal distortion by continuously sensing incoming parameters and recalculating the optimal I/Q values as the satellite and user device move. This real-time adjustment maintains accurate and reliable communication between the user device and the non-terrestrial node.

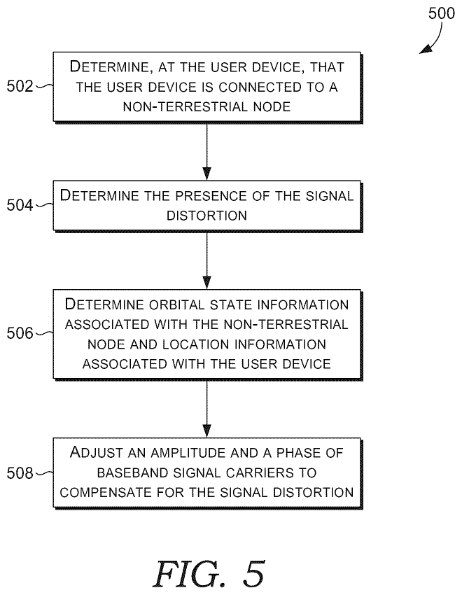

Turning now to FIG. 5, a flow chart representing a method 500 for dynamically compensating for signal distortion between a non-terrestrial node and a user device is provided. At block 502, the user device determines that it is connected to a non-terrestrial node, such as a satellite. This determination can be made through various means, including receiving specific connection signals or identifiers from the non-terrestrial node. The user device recognizes the connection and prepares to manage communication accordingly. At block 504, the presence of signal distortion is determined based on communication signaling. The user device monitors the incoming and outgoing signals for anomalies such as frequency shifts, phase changes, or amplitude variations. These distortions are often caused by the Doppler effect, which occurs due to the relative motion between the satellite and the user device. The user device detects these distortions and identifies them as signal distortion.

At block 506, orbital state information associated with the non-terrestrial node and the location information associated with the user device are determined. The orbital state information includes ephemeris data and epoch time data, which provide detailed information about the satellite's position and velocity during a given period. The ephemeris data includes position and velocity state information of the satellite, while the epoch time data indicates the satellite's orbit at a specific point along with a set of orbital elements. The user device also determines its own location information, which may include latitude, longitude, altitude, and angle of arrival. This comprehensive data set is used for accurately calculating the necessary adjustments. At block 508, based on the determined orbital state information and location information, the amplitude and phase of baseband signal carriers are adjusted to compensate for the signal distortion on uplink communications. This adjustment includes invoking variable phase shift to account for the signal distortion (e.g., modifying the phase), allowing signals to be processed accurately. The user device modifies the weights of the I/Q carriers to preemptively negate the signal distortion. Additionally, Fourier transforms may be applied to adjust transient parameters within the modulation equation, thereby changing the modulation output to reduce or increase delay and improve communication reliability.

In one aspect, to account for the signal distortion, variable phase shift is invoked. Here, the user device dynamically modifies the strength and position of its transmitted signal components. This adjustment ensures that the signals are accurately received by the non-terrestrial node, compensating for distortions such as the Doppler effect.

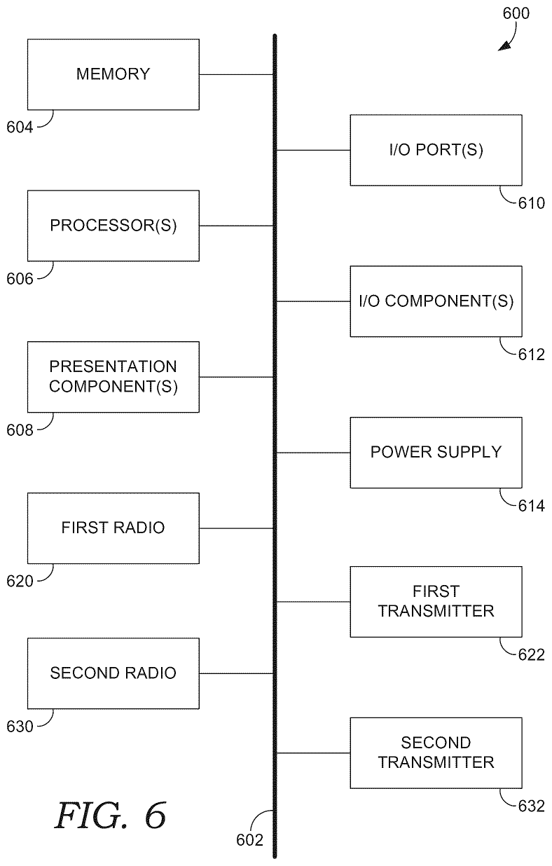

Referring to FIG. 6, an exemplary computer environment is shown and designated generally as computing device 600 that is suitable for use in implementations of the present disclosure. Computing device 600 is but one example of a suitable computing environment and is not intended to suggest any limitation as to the scope of use or functionality of the invention. Neither should computing device 600 be interpreted as having any dependency or requirement relating to any one or combination of components illustrated. In aspects, the computing device 600 is generally defined by its capability to transmit one or more signals to an access point and receive one or more signals from the access point (or some other access point); the computing device 600 may be referred to herein as a user equipment (user device), wireless communication device, or user device. The computing device 600 may take many forms; non-limiting examples of the computing device 600 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 6, computing device 600 includes bus 602 that directly or indirectly couples the following devices: memory 604, one or more processors 606, one or more presentation components 608, input/output (I/O) ports 610, I/O components 612, and power supply 614. Bus 602 represents what may be one or more buses (such as an address bus, data bus, or combination thereof). Although the devices of FIG. 6 are shown with lines for the sake of clarity, delineating various components is not so clear, and metaphorically, the lines would more accurately be grey and fuzzy. For example, one may consider a presentation component such as a display device to be one of I/O components 612. Also, processors, such as one or more processors 606, have memory. The present disclosure hereof recognizes that such is the nature of the art and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 604 includes computer-storage media in the form of volatile and/or nonvolatile memory. Memory 604 may be removable, nonremovable, or a combination thereof. Exemplary memory includes solid-state memory, hard drives, optical-disc drives, etc. Computing device 600 includes one or more processors 606 that read data from various entities such as bus 602, memory 604, or I/O components 612. One or more presentation components 608 presents data indications to a person or other device. Exemplary one or more presentation components 608 include a display device, speaker, printing component, vibrating component, etc. I/O ports 610 allow computing device 600 to be logically coupled to other devices including I/O components 612, some of which may be built in computing device 600. Illustrative I/O components 612 include a microphone, joystick, game pad, satellite dish, scanner, printer, wireless device, etc.

A first radio 620 and second radio 630 represent radios that facilitate communication with one or more wireless networks using one or more wireless links. In aspects, the first radio 620 utilizes a first transmitter 622 to communicate with a wireless network on a first wireless link and the second radio 630 utilizes the second transmitter 632 to communicate on a second wireless link. Though two radios are shown, it is expressly conceived that a computing device with a single radio (i.e., the first radio 620 or the second radio 630) could facilitate communication over one or more wireless links with one or more wireless networks via both the first transmitter 622 and the second transmitter 632. Illustrative wireless telecommunications technologies include CDMA, GPRS, TDMA, GSM, and the like. One or both of the first radio 620 and the second radio 630 may carry wireless communication functions or operations using any number of desirable wireless communication protocols, including 802.11 (Wi-Fi), WiMAX, LTE, 3G, 4G, LTE, 5G, 6G, NR, VoLTE, or other VoIP communications. In aspects, the first radio 620 and the second radio 630 may be configured to communicate using the same protocol but in other aspects they may be configured to communicate using different protocols. In some embodiments, including those that both radios or both wireless links are configured for communicating using the same protocol, the first radio 620 and the second radio 630 may be configured to communicate on distinct frequencies or frequency bands (e.g., as part of a carrier aggregation scheme). As can be appreciated, in various embodiments, each of the first radio 620 and the second radio 630 can be configured to support multiple technologies and/or multiple frequencies; for example, the first radio 620 may be configured to communicate with a base station according to a cellular communication protocol (e.g., 4G, 5G, 6G, or the like), and the second radio 630 may configured to communicate with one or more other computing devices according to a local area communication protocol (e.g., IEEE 802.11 series, Bluetooth, NFC, z-wave, or the like).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for dynamically compensating for signal distortion between a non-terrestrial node and a user device, the method comprising:
determining orbital state information associated with the non-terrestrial node;
based at least on communication signaling, determining a location associated with the user device that is connected to the non-terrestrial node;
calculating baseband signal components for carrier frequency adjustment based at least on the determined location of the user device and the orbital state information; and
based on the baseband signal components, adjusting an amplitude and a phase of baseband signal carriers to compensate for the signal distortion.

2. The method of claim 1, wherein the orbital state information comprises ephemeris data and epoch time.

3. The method of claim 2, wherein the ephemeris data includes position and velocity state information of a satellite during a given period.

4. The method of claim 2, wherein the epoch time indicates an orbit of a satellite associated with the non-terrestrial node at a specific point along with a set of orbital elements.

5. The method of claim 1, wherein calculating the baseband signal components comprises determining optimal In-phase (I) and Quadrature (Q) values for the carrier frequency adjustment.

6. The method of claim 1, wherein adjusting the amplitude and the phase of the baseband signal carriers comprises modifying weights of In-phase (I) and Quadrature (Q) carriers to preemptively compensate for the signal distortion.

7. The method of claim 1, wherein the baseband signal components are further calculated based on a distance between the non-terrestrial node and the user device and an angular velocity of the non-terrestrial node.

8. The method of claim 1, further comprising receiving communication signals from the user device, the communication signals comprising at least one of an angle of arrival, a latitude, a longitude, or altitude information.

9. The method of claim 1, wherein adjusting the amplitude and the phase of the baseband signal carriers to compensate for the signal distortion comprises applying a Fourier transform.

10. The method of claim 1, where the signal distortion is a Doppler effect.

11. The method of claim 1, further comprising implementing a feedback loop to continuously monitor and update the baseband signal components based on changes in the location of the user device and the orbital state information.

12. A system for dynamically compensating for signal distortion, the system comprising:
a non-terrestrial node configured to provide wireless coverage to a user device; and
one or more computer processing components configured to perform operations comprising:
receiving an indication that signal distortion is present based on communications between the non-terrestrial node and the user device;
determining orbital state information associated with the non-terrestrial node;
based at least on communication signaling, determining a location associated with the user device that is connected to the non-terrestrial node;
calculating baseband signal components for carrier frequency adjustment based at least on the determined location of the user device and the orbital state information;
based on the baseband signal components, adjusting an amplitude and a phase of baseband signal carriers to compensate for the signal distortion; and
implementing a feedback loop to continuously monitor and update the baseband signal components based on changes in the location of the user device and the orbital state information.

13. The system of claim 12, wherein the orbital state information comprises at least ephemeris data and epoch time.

14. The system of claim 12, where the signal distortion is a Doppler effect.

15. The system of claim 12, wherein calculating the baseband signal components comprises determining optimal In-phase (I) and Quadrature (Q) values for the carrier frequency adjustment.

16. The system of claim 12, wherein adjusting the amplitude and the phase of the baseband signal carriers to compensate for the signal distortion comprises applying a Fourier transform.

17. The system of claim 13, wherein the ephemeris data includes position and velocity state information of a satellite during a given period and the epoch time indicates an orbit of a satellite associated with the non-terrestrial node at a specific point along with a set of orbital elements.

18. A method for dynamically compensating for signal distortion between a non-terrestrial node and a user device, the method comprising:
determining, at the user device, that the user device is connected to the non-terrestrial node;
based on communication signaling, determining a presence of the signal distortion;
determining orbital state information associated with the non-terrestrial node and location information associated with the user device; and
adjusting an amplitude and a phase of baseband signal carriers to compensate for the signal distortion on uplink communications.

19. The method of claim 18, further comprising invoking variable phase shift to account for the signal distortion allowing signals to be processed.

20. The method of claim 18, wherein the signal distortion is a Doppler effect.
